(19) United States
(12) Patent Application Publication
(10) Pub. No.: US 2012/0079399 A1
(43) Pub. Date: Mar. 29, 2012

(54) Methods and Systems for Routing Meeting-Related Content

(76) Inventors: Ahmet Mufit Ferman, Vancouver, WA (US); Basil Isaiah Jesudason, Portland, OR (US)

(21) Appl. No.: 12/892,387

(22) Filed: Sep. 28, 2010

(51) Int. Cl. G06F 3/01

(52) U.S. Cl. 715/753

(57) ABSTRACT

Aspects of the present invention are related to systems and methods for routing meeting-related content to destinations associated with meeting participants.

### FIELD OF THE INVENTION

Embodiments of the present invention relate generally to content routing and, in particular, to routing meeting-related content to destinations associated with meeting participants.

### BACKGROUND

Online collaboration tools may enable users at one, or more, locations to participate in a meeting and to exchange information in real time. Convenient methods and systems for dissemination, to meeting participants, of meeting-related content may be desirable.

### SUMMARY

Some embodiments of the present invention comprise methods and systems for routing meeting-related content to destinations associated with meeting participants. According to a first aspect of the present invention, one, or more, personal content containers may be associated with a meeting participant. According to a second aspect of the present invention, each personal content container may correspond to a destination to which meeting-based content may be routed. According to a third aspect of the present invention, personal content containers associated with a meeting participant may be defined in a user profile associated with the meeting participant.

In some embodiments of the present invention, a device associated with a meeting participant may be incorporated into a meeting space as a potential destination for meeting-based content.

In some embodiments of the present invention, meeting-based content may be routed to a destination by dragging an iconic representation of the content onto an iconic representation of the destination.

In some embodiments of the present invention, a destination associated with a meeting participant may be added to the meeting space when the meeting participant is authenticated and added to the meeting.

In some embodiments of the present invention, a destination associated with a meeting participant's device may be added to the meeting space when the device is detected in proximity to the meeting.

In some embodiments of the present invention, a meeting participant in a remote location may directly copy meeting-based content to a device at another site by means of a virtualized link maintained by a central meeting server.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture illustrating exemplary embodiments of the present invention comprising a meeting server, remote meeting sites and mobile meeting participants;

FIG. 2 is a picture illustrating an exemplary meeting-application window according to some embodiments of the present invention;

FIG. 3 is a picture depicting iconic representations of meeting participants and associated personal content containers according to embodiments of the present invention;

FIG. 4 is a picture depicting an iconic representation of a meeting participant and his associated personal content containers according to embodiments of the present invention; and

FIG. 5 is a chart showing exemplary embodiments of the present invention comprising meeting-content routing initiated by a user-interface action in association with a meeting-participant indicator.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

Online collaboration tools may enable users at one, or more, locations to participate in a meeting and to exchange information in real time. Convenient methods and systems for dissemination, to meeting participants, of meeting-related content may be desirable.

If a meeting participant, also referred to as a participant or a user, wishes to obtain meeting-related content associated with a meeting, for example, artifacts produced during the meeting, content consumed during the meeting and other meeting-related content, the meeting participant may need to access a file system outside of the collaboration tool to locate and copy the required content to one, or more, desired destinations. This may be a cumbersome and tedious process. Furthermore, a desired destination may not be directly available to the meeting participant. For example, the meeting participant may wish to receive a copy of a meeting-related document on his mobile device, and unless the device is readily visible to, and accessible by, the collaboration tool, the meeting-related document only may be routed to the mobile device using an indirect means, for example, by email. Additionally, some meeting artifacts may be visible only while the meeting is active within the collaboration tool.

Embodiments of the present invention comprise methods and systems to conveniently route meeting-related content, also referred to as meeting content.

In some embodiments of the present invention, a device associated with a meeting participant may be incorporated into a meeting space as a potential destination for meeting-based content. In some embodiments of the present invention, meeting-based content may be routed to a destination by dragging an iconic representation of the content onto an iconic representation of the destination. In some embodiments of the present invention, a destination associated with a meeting participant may be added to the meeting space when the meeting participant is authenticated and added to the meeting. In some embodiments of the present invention, a destination associated with a meeting participant's device may be added to the meeting space when the device is detected in proximity to the meeting. In some embodiments of the present invention, a meeting participant in a remote location may directly copy meeting-based content to a device at another site by means of a virtualized link maintained by a central meeting server.

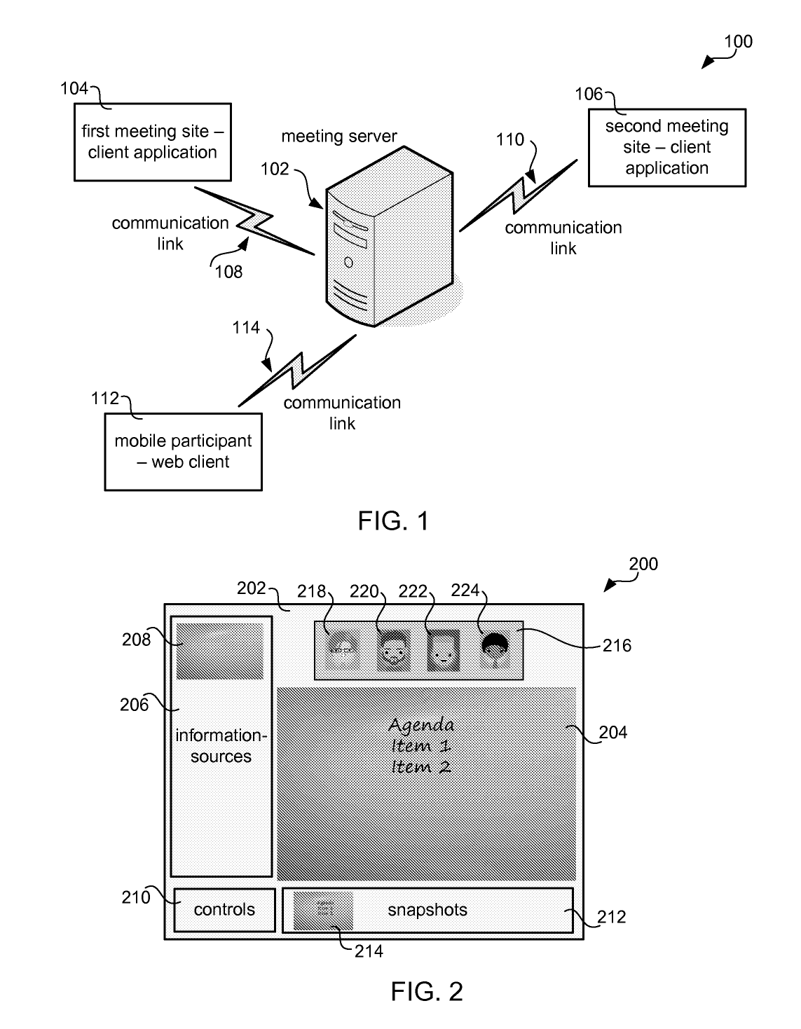

Some embodiments of the present invention may be described in relation to FIG. 1. FIG. 1 depicts an exemplary meeting system 100 comprising a meeting server 102 that may facilitate communication between various meetings sites (two shown 104, 106) and may be a repository for meeting-related content. The meeting sites 104, 106 may be communicatively coupled to the meeting server 102 by a communication link 108, 110 that may be a wired, a wireless or other communication link. A meeting site 104, 106 may be equipped with hardware, for example, a personal computer, a meeting appliance comprising an embedded processor and other hardware, on which a client meeting application may run. Additionally, a meeting site 104, 106 may be equipped with one, or more, displays, collaborative writing surfaces and other peripheral devices. Exemplary collaborative writing surfaces may include a flipchart, a whiteboard, a chalkboard, a piece of paper and other physical writing surfaces. A meeting site 104, 106 may be equipped with one, or more, microphones, cameras and other meeting-capture devices. A meeting-capture device may allow capture and transmission of multimedia streams and may allow meeting participants to share the content on local collaborative writing surfaces with remote attendees via the meeting server 102. A mobile participant (one shown 112) who is not physically located at a meeting site 104, 106 may join a meeting by means of a web client provided they have a communication link 114 providing web access.

In some embodiments of the present invention, a meeting host participant residing at a meeting site may invoke a meeting application that may allow both local meeting participants and remote meeting participants to join a meeting and participate and collaborate in the meeting. Meeting content may be generated and modified during the meeting. Exemplary meeting content may include documents, images, audio and video streams and other meeting content. Meeting participants at various locations may view collaborative writing surfaces at remote sites and may dynamically edit electronic copies of the content. Additionally, the meeting application may automatically generate indexes, also considered markers, on a meeting timeline based on an assessment of the significance of the meeting content. In some embodiments of the present invention, a marker may comprise a screenshot of a collaborative writing surface or other camera-view associated with the meeting, and may be used by participants to browse a meeting history and randomly access an earlier instance in the meeting for review.

Some embodiments of the present invention may be described in relation to FIG. 2. FIG. 2 illustrates an exemplary meeting-application window 200. A meeting-application window 200 may comprise a display region 202 that may contain a frame 204 wherein the current shared content, for example, a view of a collaborative writing surface, may be presented. The meeting-application window 200 may comprise an information-source region 206 that may contain iconic representations, or other representations, (one shown 208) of available information sources, for example, a video stream, a collaborative writing surface from a meeting room, a document, a web page and other available information sources. A meeting participant may share an information source by dragging the icon of the desired source from the information-source region 206 to the display region 202. The meeting-application window 200 may further comprise a control region 210 that may contain meeting controls for example, editing, saving, view manipulation and other meeting controls. The meeting-application window 200 may additionally comprise a snapshot region 212 that may contain icons, or other indicators, of automatically or manually acquired snapshots (one shown 214) of the content in the display region 202. In some embodiments, a meeting participant may access a snapshot by hovering over the associated icon with his cursor, and may bring a past view associated with the icon into the display region 202 by clicking on the icon.

According to some embodiments of the present invention, a meeting-application window 200 may comprise a meeting-participant region 216 in which an icon, or other indicator, associated with a meeting participant (four shown 218, 220, 222, 224) may be displayed. In some embodiments of the present invention, a meeting-participant indicator may appear in the meeting-participant region 216 if a person is invited to the meeting regardless of their actual participation status. In alternative embodiments of the present invention, a meeting-participant indicator may appear in the meeting-participant region 216 only when the participant is physically in attendance. In some embodiments, physical attendance may be explicitly entered into, and authenticated by, the meeting application. In alternative embodiments, a meeting participant's presence status may be automatically detected, for example, by a proximity detector in conjunction with a participant identification badge that may, for example, comprise an embedded RFID (Radio-Frequency IDentification) tag or other contactless communication capability, for example, Felica by Sony. In some embodiments, when an invited participant is not in attendance at the meeting, the meeting-participant indicator associated with the invited participant may be displayed in a different state than those of attending participants. For example, in some embodiments, the icon associated with an invited participant not in attendance may be displayed in gray-scale, while the icon associated with an invited participant in attendance may be displayed in color.

A meeting-application window may take other formats than the exemplary meeting-application window shown in FIG. 2. For example, in some embodiments of the present invention, a meeting-application window may comprise a meeting-participant region and a content region. The content region may comprise content indicators indicating meeting-based content associated with a meeting instance.

In some embodiments of the present invention, a first meeting participant may route meeting-related content to a content container associated with a second meeting participant, for example, another meeting participant or himself. In some embodiments of the present invention, a first meeting participant may route meeting-related content to a common resource content container.

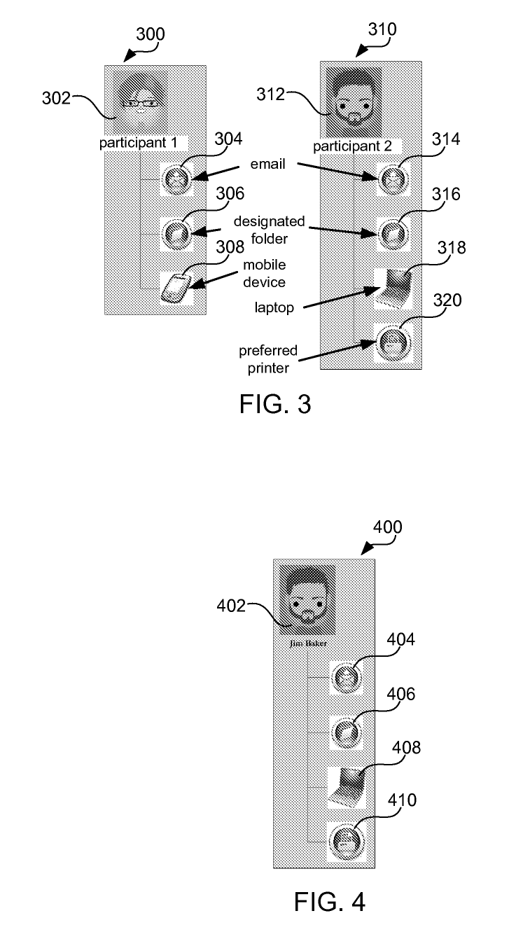

In some embodiments of the present invention illustrated in relation to FIG. 3, each meeting participant (two shown 300, 310) may be associated with one, or more, personal content containers (PCCs), for example, an email address, a folder on an enterprise network, a registered mobile device, a peripheral device, for example, a printer, a multifunction peripheral or other peripheral device, a computing device, for example, a laptop computer, a desktop computer or other computing device. In this example, a first participant 300 represented by a first icon 302, which may be displayed in a meeting-participant region of a meeting-application window, may be associated with three personal content containers: a first container 304 corresponding to an email address associated with the first participant; a second container 306 designating a destination folder on an enterprise network; and a third container 308 corresponding to a registered mobile device. A second participant 310 represented by a second icon 312, which may be displayed in a meeting-participant region of the meeting-application window, may be associated with four personal content containers: a first container 314 corresponding to an email address associated with the second participant; a second container 316 designating a destination folder on an enterprise network; a third container 318 designating a laptop; and a fourth container designating a preferred printing device.

In some embodiments of the present invention, a list of PCCs associated with a meeting participant may be revealed by double-clicking on the meeting-participant indicator, in the participant region, associated with the meeting participant. In alternative embodiments of the present invention, a list of PCCs associated with a meeting participant may be revealed by hovering the cursor over the meeting-participant indicator, in the participant region, associated with the meeting participant. In yet alternative embodiments of the present invention, a list of PCCs associated with a meeting participant may be revealed by expanding a tab next to the meeting-participant indicator, in the participant region, associated with the meeting participant. Other user-interface actions known in the art for revealing a sub-menu associated with meeting-participant indicator may be used in some embodiments of the present invention. FIG. 4 illustrates an exemplary image 400 showing an image that may appear in response to a request to display the PCCs associated with a meeting participant. The participant icon 402 may be displayed along with icons 404, 406, 408, 410 each corresponding to a particular PCC. In alternative embodiments of the present invention, PCCs may be represented by a PCC indicator other than a PCC icon.

In some embodiments of the present invention, a user-interface action, for example, a click, a double click, a drag-and-drop action or other user-interface action, in a region associated with the meeting-participant indicator may result in the routing of meeting content to a default content container associated with the meeting participant represented by the meeting-participant indicator. A user-interface action in a region associated with an indicator corresponding to a particular PCC may result in the routing of meeting content to the content container corresponding to the PCC indicator. The routing action routes selected meeting content from a content repository associated with the meeting server to the selected destination.

In some embodiments of the present invention, a user may designate his preferred PCCs in an associated profile that may be accessible to a meeting application. In some embodiments, a default container may be designated in a user's associated profile. In some embodiments the default container may be explicitly designated. In alternative embodiments, the default container may be an email address associated with the user. In some exemplary embodiments of the present invention, a user profile may be represented in XML format. In alternative embodiments, a user profile may be represented in one of many formats known in the art.

In some embodiments of the present invention, a device brought into a meeting room by a participant may be automatically added, by the meeting application, to a list of PCCs associated with the participant. In some embodiments, the device may be authenticated prior to its addition to the participant's PCCs. In some embodiments, all devices, in a meeting room, with Bluetooth support may be automatically paired with the meeting computer upon detection of their presence. In some embodiments, a one-time discovery and setup step may be required to register a new device with a meeting application. The meeting application may retain a list of all registered devices, and may automatically authenticate a registered device when the device is detected within range of a meeting site. During device registration, a personal device, for example, a laptop, a mobile device or other personal device, may be associated with a participant, or a public, also considered shared, device, for example, a printer, a multifunction peripheral or other shared device, may be associated so as to be available to any participant.

In some embodiments of the present invention, a user profile may comprise filter parameters against which meeting content may be filtered prior to routing. In one example, a user profile may comprise a filter parameter that may indicate a size limit for content that is routed to a particular device. In some situations, the size limit may be dictated by the properties of the device. For example, a user may elect to receive all meeting content on a network drive, but may only wish to receive, on his mobile device, meeting content less in overall size than a size-limit value indicated in a size-limit parameter, in order to avoid data transfer fees. In another example, a user profile may comprise a filter parameter associated with content type. For example, a user may elect to only receive image content on a network drive. Other examples may comprise filter parameters associated with other content characteristics.

In some embodiments of the present invention, a user profile may specify content preferences. In one example, a user may elect to receive only audio information collected during a meeting. In another example, a user may elect to receive image-only versions of meeting content, rather than, for example, MS Word files. These preferences may be dictated by the capabilities of the content destinations, also considered devices, associated with the user.

In some embodiments of the present invention, an informative message may be automatically sent to a user based on detection of a predefined meeting event. In some embodiments of the present invention, the predefined meeting event may be specified in the user profile. In alternative embodiments, the predefined meeting event may be specified by the meeting server. In yet alternative embodiments, the predefined meeting event may be specified by other meeting characteristics. The informative message may trigger a user to set, or modify, his content-routing settings. In one exemplary embodiment, if content is routed to a user's default content container through a drag-and-drop event, the intended recipient may be notified of the impending action and allowed to modify the container designation.

In some embodiments of the present invention, a meeting application may execute batch processing of specific tasks upon occurrence of a predefined user-interface event. In one exemplary embodiment, select meeting content may be routed to a user's default content container when the user leaves the meeting. In some embodiments, the user's meeting-presence status may be automatically detected. In another exemplary embodiment, select meeting content may be compiled and forwarded automatically to all participants upon termination of the meeting. These embodiments obviate the need for a meeting facilitator to manually compile and send content to each participant individually.

In some embodiments of the present invention, a user profile may comprise a content-routing preference based on a meeting characteristic, for example, meeting type, meeting location, meeting frequency or other meeting characteristic. For example, a user may elect to receive minimal meeting content when attending a meeting from a remote location, compared to complete meeting materials when attending a meeting on site. In another example, a user may elect to receive only action-item data for a daily meeting, while electing to receive a full meeting report for a monthly project review meeting.

In some embodiments of the present invention, meeting content may be disseminated based on participant authority. In these embodiments, meeting content may be routed to meeting participants only by a select participant with explicit authority. A meeting may have one, or more, hosts, or facilitators, that may have expanded routing privileges. In some embodiments of the present invention, in order to route content to other participants, a user may be required to possess facilitator privileges. In some embodiments, a meeting participant may request an expanded routing privilege from the designated meeting host(s) and may be granted expanded rights to perform various tasks.

In some embodiments of the present invention, when a PCC is unavailable, the indicator associated with the PCC may be displayed in a different state than an available PCC. For example, in some embodiments, the indicator associated with an unavailable PCC may be displayed in gray-scale, while an indicator associated with an available PCC may be displayed in color. A PCC may be unavailable, for example, when a user's profile includes a number of mobile devices, for example, a smart phone, a laptop, a personal digital assistant and other mobile devices, and one of these devices is not powered on during the meeting or the device's presence is not detected by the meeting application.

In some embodiments of the invention, a meeting application may provide an acknowledgment of successful content delivery to the intended destination once the transmission concludes. This verification may ensure that routing is accomplished without any problems. If transmission fails, an error notification, along with the reason for failure, may also be provided. In some embodiments of the present invention, a meeting participant user profile may comprise an email address to which transmission messages may be sent.

In some embodiments of the present invention, a meeting application may provide a practical means for creating and maintaining a user profile. In some embodiments, a user may be presented with a (graphical) user interface that may allow the user to indicate his various meeting-related preferences by enabling (or disabling) predefined settings. In alternative embodiments, a user may edit his preferences using an editing tool, for example, a text editor or other editing tool.

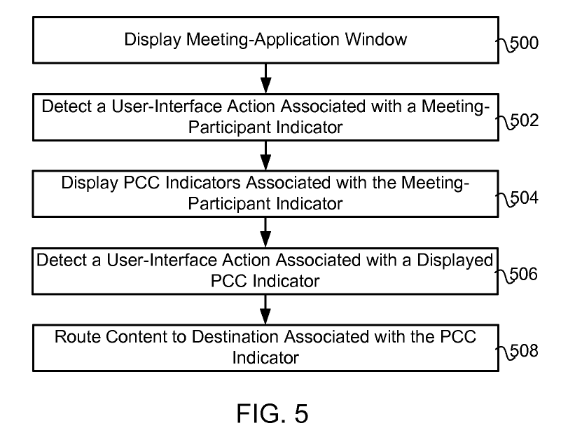

Some embodiments of the present invention may be described in relation to FIG. 5. A meeting application may display 500 a meeting-application window. A first user-interface action may be detected 502 in association with a meeting-participant indicator. In response to the first user-interface action, a plurality of PCCs associated with the meeting-participant indicator may be displayed 504. A second user-interface action may be detected 506 in association with a first displayed PCC in the plurality of PCCs associated with the meeting-participant indicator. A meeting content may be routed 508 to a destination associated with the first displayed PCC indicator.

In some embodiments of the present invention, content routing and storage may be implemented using web services. A user-interface action that initiates content routing to a personal content container may effectuate generation of a web-service-based message to initiate the content transfer. In some embodiments, the web-service-based messaging system may send the message to initiate the content transfer locally using a Bluetooth connection.

In some embodiments of the present invention, meeting-based content may be stored on a meeting server. In alternative embodiments of the present invention, meeting-based content may be stored on a remote storage coupled to a meeting server.

In some embodiments of the present invention, user profiles may be stored on a meeting server. In alternative embodiments of the present invention, user profiles may be stored on a remote storage coupled to a meeting server.

Although the charts and diagrams in the figures described herein may show a specific order of execution, it is understood that the order of execution may differ from that which is depicted. For example, the order of execution of the blocks may be changed relative to the shown order. Also, as a further example, two or more blocks shown in succession in a figure may be executed concurrently, or with partial concurrence. It is understood by those with ordinary skill in the art that software, hardware and/or firmware may be created by one of ordinary skill in the art to carry out the various logical functions described herein.

Some embodiments of the present invention may comprise a computer-program product that is a computer-readable storage medium, and/or media, having instructions stored thereon, and/or therein, that may be used to program a computer to perform any of the features presented herein. Some embodiments of the present invention may comprise a computer program product comprising a computer-readable storage medium having instructions stored thereon/in which may be used to program a computing system to perform any of the features and methods described herein. Exemplary computer-readable storage media may include, but are not limited to, flash memory devices, disk storage media, for example, floppy disks, optical disks, magneto-optical disks, Digital Versatile Discs (DVDs), Compact Discs (CDs), micro-drives and other disk storage media, Read-Only Memory (ROMs), Programmable Read-Only Memory (PROMs), Erasable Programmable Read-Only Memory (EPROMS), Electrically Erasable Programmable Read-Only Memory (EEPROMs), Random-Access Memory (RAMS), Video Random-Access Memory (VRAMs), Dynamic Random-Access Memory (DRAMs) and any type of media or device suitable for storing instructions and/or data.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for routing meeting-related content, said method comprising:
displaying a meeting-application window comprising a participant region comprising a first meeting-participant indicator associated with a first meeting participant;
detecting a first user-interface action associated with said first meeting-participant indicator;
displaying a first personal content container indicator associated with said first meeting participant in response to said detected first user-interface action;
detecting a second user-interface action associated with said first personal content container indicator; and
routing a first meeting-based content to a first destination associated with said first personal content container.

2. A method as described in claim 1, wherein said first destination is defined in a first user profile associated with said first meeting participant.

3. A method as described in claim 2, wherein said first user profile comprises a first filter parameter associated with a content size limit.

4. A method as described in claim 2, wherein said first user profile comprises a default personal content container designator.

5. A method as described in claim 2, wherein said first user profile comprises a first filter parameter associated with a meeting characteristic.

6. A method as described in claim 2 comprises a first filter parameter associated with a content characteristic.

7. A method as described in claim 1, wherein:
said first meeting-participant indicator is displayed according to a first method when said first meeting participant is detected in attendance at a meeting associated with said meeting-application window; and
said first meeting-participant indicator is displayed according to a second method when said first meeting participant is not detected in attendance at said meeting.

8. A method as described in claim 1 further comprising detecting the presence status of said first meeting participant.

9. A method as described in claim 1, wherein:
said first personal content container indicator is displayed according to a first method when said first destination is available; and
said first personal content container indicator is displayed according to a second method when said first destination is not available.

10. A method as described in claim 1, wherein said first personal content container is associated with a first device.

11. A method as described in claim 10 further comprising authenticating said first device.

12. A method as described in claim 10, wherein said first device is a personal device selected from the group consisting of a laptop computer, a mobile phone, a personal digital assistant and a tablet computer.

13. A method as described in claim 12 further comprising detecting the proximity of said first device to a first meeting site associated with a meeting associated with said meeting-application window.

14. A method as described in claim 10, wherein said first device is a shared device.

15. A method as described in claim 1 further comprising sending an acknowledgement message associated with said routing.

16. A method as described in claim 15, wherein said acknowledgement message is sent to an email address specified in a user profile associated with said first meeting participant.

17. A method as described in claim 1, wherein said participant region comprises a plurality of meeting-participant indicators, wherein each meeting-participant indicator in said plurality of meeting-participant indicators is associated with an invited participant to a meeting associated with said meeting-application window.

18. A method as described in claim 1, wherein:
said first meeting-participant indicator is a first meeting-participant icon; and
said first personal content container indicator is a first personal content container icon.

19. A method for routing meeting-related content, said method comprising:
displaying a meeting-application window comprising a participant region comprising a first meeting-participant indicator associated with a first meeting participant;
detecting a first user-interface action associated with said first meeting-participant indicator; and
routing a first meeting-based content to a default destination associated with said first meeting participant.

20. A method as described in claim 19, wherein said default destination is defined in a first user profile associated with said first meeting participant.

21. A method as described in claim 20, wherein said first user profile comprises a first filter parameter associated with a content size limit.

22. A method as described in claim 20, wherein said first user profile comprises a first filter parameter associated with a meeting characteristic.

23. A method as described in claim 20 comprises a first filter parameter associated with a content characteristic.

24. A method as described in claim 19, wherein:
said first meeting-participant indicator is displayed according to a first method when said first meeting participant is detected in attendance at a meeting associated with said meeting-application window; and
said first meeting-participant indicator is displayed according to a second method when said first meeting participant is not detected in attendance at said meeting.

25. A method as described in claim 19 further comprising detecting the presence status of said first meeting participant.

26. A method as described in claim 19, wherein said default personal content container is associated with a first device.

27. A method as described in claim 26 further comprising authenticating said first device.

28. A method as described in claim 26, wherein said first device is a personal device selected from the group consisting of a laptop computer, a mobile phone, a personal digital assistant and a tablet computer.

29. A method as described in claim 28 further comprising detecting the proximity of said first device to a first meeting site associated with a meeting associated with said meeting-application window.

30. A method as described in claim 26, wherein said first device is a shared device.

31. A method as described in claim 19 further comprising sending an acknowledgement message associated with said routing.

32. A method as described in claim 31, wherein said acknowledgement message is sent to an email address specified in a user profile associated with said first meeting participant.

33. A method as described in claim 19, wherein said participant region comprises a plurality of meeting-participant indicators, wherein each meeting-participant indicator in said plurality of meeting-participant indicators is associated with an invited participant to a meeting associated with said meeting-application window.

34. A method as described in claim 19, wherein said first meeting-participant indicator is a first meeting-participant icon.
